(19) United States
(12) Patent Application Publication
(10) Pub. No.: US 2022/0070894 A1
(43) Pub. Date: Mar. 3, 2022

(54) SCHEDULING REQUEST FOR RADIO ACCESS NETWORKS WITH BEAMFORMING

(71) Applicant: Telefonaktiebolaget LM Ericsson (publ), Stockholm (SE)

(72) Inventors: Stefan PARKVALL, Bromma (SE); Robert BALDEMAIR, Solna (SE); Håkan BJÖRKEGREN, Täby (SE); Claes TIDESTAV, Bålsta (SE)

(21) Appl. No.: 17/419,811

(22) PCT Filed: Dec. 30, 2018
(86) PCT No.: PCT/SE2018/051376

§ 371 Date: Jun. 30, 2021

(51) Int. Cl. H04W 72/12

(52) U.S. Cl. CPC H04W 72/1268; H04W 72/1205

(57) ABSTRACT

There is disclosed a method of operating a network node in a radio access network. The method includes configuring at least one user equipment, UE, with an uplink transmission configuration for transmission of uplink signaling based on a reception beam configuration of the network node. The disclosure also pertains to related methods and devices.

### TECHNICAL FIELD

This disclosure pertains to wireless communication technology, in particular in the context of beamforming for radio access networks.

### BACKGROUND

In wireless communication networks like LTE or NR, a user equipment (UE) without sufficient uplink resources for data transmission usually transmits a scheduling request to the network to indicate that it has data to transmit. With the wide-spread use of reception beamforming on the network side, new challenges for handling of scheduling requests and/or resource allocation appear.

### SUMMARY

It is an object of the present disclosure to provide approaches providing Improved handling of scheduling request and/or resource allocation when reception beamforming is used by the network. In the following, an uplink transmission configuration may be referred to as UL TX configuration.

The approaches are particularly advantageously implemented in a 5th Generation (5G) telecommunication network or 5G radio access technology or network (RAT/RAN), in particular according to 3GPP (3rd Generation Partnership Project, a standardisation organization). A suitable RAN may in particular be a RAN according to NR, for example release 15 or later, or LTE Evolution.

There is disclosed a method of operating a network node in a radio access network. The method comprises configuring at least one user equipment with an uplink transmission configuration for transmission of uplink signaling based on a reception beam configuration of the network node.

Moreover, a network node for a radio access network is described. The network node is adapted for configuring at least one user equipment with an uplink transmission configuration for transmission of uplink signaling based on a reception beam configuration of the network node. The network node may comprise, and/or be adapted for utilising, processing circuitry and/or radio circuitry, for determining the UL TX configuration and/or transmitting the UL TX configuration and/or for receiving uplink signaling transmitted based on the UL TX configuration.

Also, a method of operating a user equipment in a radio access network is proposed. The method comprises transmitting uplink signaling based on a uplink transmission configuration configured to the user equipment, wherein the uplink transmission configuration may be based on a beam reception beam configuration of a network node.

A user equipment for a radio access network is described. The user equipment is adapted for transmitting uplink signaling based on an uplink transmission configuration configured to the user equipment, wherein the uplink transmission configuration may be based on a beam reception beam configuration of a network node. The user equipment may comprise, and/or be adapted for utilising, processing circuitry and/or radio circuitry, for receiving the UL TX configuration and/or for transmitting the uplink signaling and/or for determining whether to transmit.

The approaches described herein allow efficient use of resources for reception beamforming. In particular, beam sweeping may be handled efficiently from the network side.

The reception beam configuration may represent analog or hybrid reception beamforming. Analog and/or hybrid beamforming requires lower processing power for the receiving node than digital beamforming. However, solutions in which a beam is formed with digital beamforming may be considered.

The reception beam configuration may in general represent beam sweeping and/or beam switching. Beam sweeping may represent moving a beam (e.g., with constant beam shape) in a continuous motion in angular direction (continuous at least over selected time intervals, it may e.g. reset after a certain time), e.g. vertically and/or horizontally. Beam switching may correspond to non-continuous motion in angular direction, e.g. vertically and/or horizontally, e.g. switching between different beams. The beams may have the same shape, or different shapes. With beam sweeping or switching, a large angular range may be covered even if only a low number of beams is used, e.g. for time-multiplexing of transmissions of multiple UEs.

The uplink transmission configuration may represent an (or more than one) opportunity for transmission of a scheduling request on a physical uplink control channel. The scheduling request may represent 1 bit or more than 1 bits. In this context, a Buffer Status Report (BSR) indicating how much data (or an estimate or range thereof) a UE has in its buffer for transmission, e.g. for a channel or channel group or bearer or bearer group, may be considered a scheduling request, in particular if it indicates that there is data to be transmitted. Thus, different forms of SR may be accommodated.

It may be considered that the uplink transmission configuration represents an opportunity for transmission of a scheduling request on a physical uplink control channel, wherein the scheduling request is represented by a long transmission, and/or repeated N times. The long transmission may cover 7 or more symbols, e.g. up to, or exactly 14 symbols, which may include symbols carrying DMRS associated to the PUCCH, e.g. 1 DMRS symbol for each symbol carrying UCI/SR. The SR may be repeated for example N=1.2.,3,4,5,6 times. (corresponding to N+1 transmissions of the SR), e.g. in a slot, or crossing slot boundaries. Each transmission may in some examples cover one or more symbol time intervals, e.g. 1 or 2 symbols (which may include 1 symbol for DMRS associated to the SR). The SR may in general be considered Uplink Control Information (UCI), and/or payload for the PUCCH transmission. Accordingly, a short sweep of a beam may be sufficient for the network node to recognise the SR from the format used. In general, the long format for PUCCH may be such that the gNB may determine its content and/or the presence of a SR from a short reception, e.g. over 1, 2 or 3 symbol time intervals. Determination may for example be based on pattern and/or resources and/or sequence (of the UCI and/or DMRS) and/or otherwise directly or indirectly.

In some examples, the uplink transmission configuration may represent an opportunity for transmission on a physical uplink shared channel, wherein the uplink transmission configuration may be configured preempting, and/or in lieu of, a scheduling request. Thus, the network node may save configuring resources for SRs and may be ready to receive data and/or signaling on PUSCH (e.g., UCI on PUSCH) instead of monitoring for a SR.

It may be considered that the uplink transmission configuration is scheduled dynamically and/or with physical layer signaling, in particular downlink control information signaling. This allows short-term adaption to changes in operation conditions.

In some cases, the uplink transmission configuration may be configured semi-statically and/or with higher layer signaling, in particular RRC signaling, e.g. alternatively, or additionally to physical layer signaling. For example, physical layer signaling may indicate on or more resources out of a set of resources configured via higher-layer signaling. However, in some cases, semi-static signaling (higher-layer signaling) may be used without physical layer signaling, e.g. to semi-statically indicate transmission resources, e.g. for the uplink transmission configuration).

It may be considered that the uplink transmission configuration represents an opportunity of transmission of multiple feedback-independent scheduling requests. Thus, the SRs may be transmitted automatically, e.g. without waiting for the network node to respond. In this case, the UE may only expect one scheduling grant for the series of repetitions. This approach increases the chances of the network node receiving at least one SR with a beam or beam instance.

The uplink transmission configuration may alternatively, or additionally, represent an opportunity of transmission of a scheduling request in a format covering a plurality of M symbol time intervals. M may be larger than 7, in particular it may be 14. The format may cover one slot, or may cross slot borders.

It may be considered that the uplink transmission configuration and/or reception beam configuration indicates a mapping between a downlink transmission beam (a beam in which a network node transmits, e.g. signaling including reference signaling), and an uplink transmission (for transmitting uplink signaling) and/or a reception beam of the network node (for receiving the uplink signaling). The mapping may in particular map a timing and/or identity and/or form of a downlink transmission beam (respectively, of signaling in the beam received by the UE) to a transmission timing. For different reception timings there may be different transmission timings. Transmission timings may for example correspond to transmission resources, e.g. PUSCH and/or PUCCH resources, which may be configured to the UE, e.g. as part of the UL TX configuration.

Also, there is considered a program product comprising instructions adapted for causing processing circuitry to control and/or perform a method as described herein. A carrier medium arrangement carrying and/or storing a corresponding program product is proposed. A system comprising at least one network node and/or at least one UE is also considered. Further, an information system as described herein is proposed.

An opportunity for reception or transmission may correspond to time and/or frequency resource/s for reception or transmission, respectively. An opportunity may be configured or configurable, e.g. by a network node to a UE.

Reception beamforming may correspond to forming beams for reception, e.g. by not receiving and/or discarding signaling from off-beam. Reception beamforming may in particular be achieved by controlling phase and/or timing of reception. Different beams and/or different beam instances, in particular of reception beams, may be associated to the same antenna arrangement and/or antenna subarray; it may be considered that the same antenna elements may be used to form such beams/beam instances. A reception beam may cover one or more UEs (or no UE, in some cases), e.g. depending on beam shape and/or form and/or direction and/or length and/or UE arrangement or movement.

In general, uplink signaling may be beamformed by the UE, or nor be beamformed. It may be considered that uplink signaling is transmitted in an uplink beam, which may be paired with, and/or associated to, a reception beam of the network node, e.g. based on the uplink transmission configuration, and/or based on communication between the UE and network node, e.g. regarding measurements on reference signaling and/or measurement reporting.

Scheduling (of uplink resources and/or uplink transmission) may be considered a form of configuring uplink transmission. Scheduling may be configuring based on dynamic signaling and/or physical layer signaling, e.g. with DCI signaling, in particular a scheduling grant and/or uplink grant. Such scheduling may be considered dynamic, which may be valid for one occasion, or a low number of occasions, and/or pertain to one or few slots. Uplink resources or uplink transmission may also be configured or granted with higher-layer signaling, e.g. RRC signaling (semi-static signaling). In this case, the grant may be valid over a long timeframe, e.g. multiple slots and/or multiple subframes and/or multiple frames and/or for an indefinite duration (e.g., until revoked or changed) and/or may defined multiple occasions for transmission or reception, e.g. in specified time intervals, e.g. regular and/or periodic time intervals.

A radio node may determine a best beam from multiple beams (or different instances of a beam from a beam undergoing beam sweeping or beam switching). Such determining may be based on signal strength and/or signal quality, which may for example be measured based on reference signaling transmitted with the beam. The reference signaling may correspond to SSB (or SS/PBCH) block signaling, and/or CSI-RS, e.g. to be measured by a UE. However, other forms of reference signaling may be measured on; for example, a network node may determine a best beam based on SRS transmitted by a UE. A best beam may be based on a prediction or estimation, e.g. of movement of the UE. In some cases, a best beam may be based on the uplink transmission configuration, which for example may indicate one or more criteria for determining the best beam, and/or may indicate which beams the best beam may be determined on. In this context, a beam instance in time of a time-dependent (e.g., swept) beam may be considered a beam. A best beam may be represented by a time and/or timing. To a best beam there may be associated and/or paired a beam in the opposite communication direction, as uplink beam, and/or a reception beam for the transmitter. The associated and/or paired beam/s may be identical to the best beam, or be similar, and/or overlap, and/or encompass the best beam, and/or be covered by the best beam. In particular, a UE may determine an uplink transmission beam, and/or a timing for uplink transmission. The timing may be associated to and/or correspond to a configured resource for uplink transmission, e.g. according to the UL TX configuration.

The reception beams and/or the uplink transmission may pertain to a carrier, or to multiple carriers. The carrier may in particular be a radio carrier, like a carrier of 1 GHz or more, or 10 GHz or more, or 50 GHz or more, and/or may be a mmW (Millimeter-Wave) carrier. However, applications with lower frequencies may be considered.

In general, an uplink transmission configuration may configure or indicate resources (or a set of resources) for transmission of uplink resources. The UL TX configuration may configure or indicate DMRS signaling, e.g. a pattern and/or resources and/or sequence and/or OCC (Orthogonal Cover Code) and/or cyclic prefix for DMRS. Different UEs may be configured differently, in particular with orthogonal DMRS (in at least one dimension/parameter). It may be considered that an UL TX configuration indicates or configures a mapping of timing and/or resources and/or identity of a beam to be received by a UE to the timing and/or resources and/or identity of signaling to be transmitted (which may be in a beam, or not beam-formed), and/or to the timing and/or resources and/or identity of a (reception) beam with which the network node receives the uplink signaling (the timings for uplink transmission and the reception beam may correspond. The UE does not necessarily have to know the form and/or shape of the reception beam, but may be configured (e.g., via the mapping) to transmit such that the network node has a beam directed to receive the uplink signaling. The mapping may be configured, e.g. with higher layer signaling like RRC or MAC signaling. In general, the UL TX configuration may be based on one or more configuration messages and/or on signaling on one or more control layers, e.g. physical layer and/or RRC layer and/or MAC layer.

The uplink signaling may be PUSCH signaling, or in some cases PUCCH signaling. PUSCH signaling may comprise data and/or an indication that the UE requires resources for transmission, e.g. a BSR and/or SR. PUCCH may comprise and/or represent a SR, e.g. a 1 bit SR.

A configuration may in general be configured to a UE with configuration or control signaling, which may indicate one or more parameters of the configuration. It may be considered that an UL TX configuration may be UE-specific, based on a UE specific identity and/or USS. However, variants in which the UL TX configuration is configured based on group signaling (e.g., broadcast or multicast, e.g. in a CSS), may be considered. Uplink signaling may be transmitted based on an identity of the UE, which for example may be used to determine the resources to be used for transmitting the UL signaling from group signaling, e.g. a resource allocation/scheduling grant received in a CSS. The identity may in particular be a RNTI assigned to the UE, e.g. a C-RNTI and/or group RNTI or other RNTI. Different UEs may determine different resources for transmitting based on the same resource allocation, e.g. due to having different identities. The resources for transmission may in general be a function of the UE identity.

### BRIEF DESCRIPTION OF THE DRAWINGS

The drawings are provided to illustrate concepts and approaches described herein, and are not intended to limit their scope. The drawings comprise:

FIG. 1, showing an exemplary uplink signaling scenario;

FIG. 2, showing another exemplary uplink signaling scenario;

FIG. 3, showing another exemplary uplink signaling scenario;

FIG. 4, showing an exemplary radio node implemented as terminal or UE; and

FIG. 5, showing an exemplary radio node implemented as network node.

### DETAILED DESCRIPTION

In the following, variants are described in the context of NR, however, the approaches may be implemented in different contexts. An gNB may be seen as representative of a network node adapted for the functionality described herein, in particular a transmission point or access point or IAB node providing radio access or a backhaul link, whereas a UE may be seen as representative as any type of radio node with similar functionality as described herein, e.g. an IAB node controlled by another IAB node or a gNB or donor node, e.g. on an access link or backhaul link.

Uplink transmissions (transmission of uplink signaling) in NR are (dynamically or semi-statically) scheduled (or configured). The gNB provides the UE with a scheduling grant (also referred to as uplink grant) indicating (among other things) time-frequency resources upon which the transmission should occur and the amount of data to transmit. Typically, the scheduling grants are dynamically signaled to the UE using DCI, but there is also a possibility to preconfigure grants using RRC (e.g. the UE can get an uplink grant configured to occur every n:th slot).

A UE with a valid scheduling grant will transmit data according to the grant if it has data available in the transmission buffer. If no data is available, the UE will either transmit nothing (if the higher-layer parameter skipUplinkTxDynamic is configured) or transmit a buffer status report (BSR) and padding (if the higher-layer parameter skipUplinkTxDynamic is not configured).

If a UE has data to transmit, but no valid grant, the UE can send a scheduling request (SR) to the gNB to indicate the presence of data in the transmission buffer. The scheduling request may be a single-bit flag indicating presence of data in the transmission buffer. Typically, the gNB will respond with a scheduling grant. Upon reception of the grant the UE can transmit (parts of) the data in the transmission buffer, as well as a buffer status report. The latter is useful for the gNB for future scheduling decisions. The opportunities for a UE to transmit a scheduling request may be semi-statically configured and may occurs at a regular interval, e.g. every n:th slot. In case no scheduling request is configured, the UE may resort to random access as a means to notify the gNB about the presence of data in the transmission buffer.

NR is designed with beamforming in mind. In general, with beamforming, (narrow) beams are formed by the gNB towards the UE and transmission and/or reception is done using one of these beams. Basically, there are two main types of beamforming:
Analog beamforming, where the beam is formed in the analog domain, in particular after digital-to-analog conversion. This restricts transmission/reception to a single beam at a time and multiplexing of different UEs primarily takes place in the time-domain (this holds per addressed antenna arrangement/subarray; there may be multiple analog beams from multiple, independent subarrays).
Digital beamforming, where the beam is formed in the digital domain, in particular before digital-to-analog conversion. In some cases, e.g. in case of a multi-carrier system, beamforming may be even in frequency-domain, e.g. forming different beams in different frequency ranges/carriers. This allows for a large or an arbitrary number of beams and beam shapes at a time, and multiplexing of different UEs can take place in both the time and frequency domains (since at one time instant different beams associated with different frequencies can be generated).
Hybrid between these two schemes can also be thought of.

Digital beamforming usually provides better flexibility, but is also more challenging to implement, especially at very high frequencies, where a large number of antenna elements typically is used. Hence, practical systems operating in mm-wave range are restricted to analog/hybrid beamforming where transmission/reception can take place at one/few direction at a time.

From the discussion above it follows that reception of a single-bit scheduling request may require the gNB to form a (analog) beam in the desired direction for one or more OFDM symbols and using the whole carrier bandwidth. During this period of time, the gNB cannot receive transmissions in any other direction. Since a relatively large number of beam directions are of interest, each which must be monitored sequentially, the cost of receiving a single-bit scheduling request can be fairly high in terms of system capacity.

In the following description it is assumed that the gNB can form one beam at a time (i.e. pure analog beamforming). The approaches can easily be extended to cover also hybrid beamforming schemes where the gNB can form a (small) number of beams but not with the full flexibility of a pure digital beamforming, and/or in which the gNB can form multiple analog beams.

### Example 1

If the gNB spends one beam to receive an SR, it can as well allow the UE to transmit data (if any). This can be achieved by providing the UE with a scheduling grant instead of an SR opportunity. If the UE has data to transmit, it will use the scheduling grant to transmit the data (including a BSR); if the UE has no data to transmit it will be silent (if the higher-layer parameter skipUplinkTxDynamic is set). The gNB can determine whether to provide the UE with subsequent grants or not, e.g. based on whether it detected energy or managed to decode data (BSR) or not.

If the scheduling grants are dynamic, this may be considered “polling” the UE for presence/absence of data, instead of providing SR opportunities.

### Example 2

An alternative, or addition, is to use a scheduling grant common to a group of UEs, to save signaling overhead, e.g. if a large number of UEs have to be scheduled. The groups can be configured, and/or be derived from the UE identity (e.g. C-RNTI), or linked to the best downlink beam. For example, the group identity can be formed as “(MSBs of C-RNTI)+(ID of strongest received SSB) or ID of configured SSB)”. More generally, a combination of information in the C-RNTI and SSB ID or solely based on the SSB ID can be used for grouping UEs Instead of basing the grouping on the “best/configured” SSB, it can be based on the “best/configured” received CSI-RS among a set of configured CSI-RS, and/or based on reference signaling in general.

Upon receiving (being configured with) a scheduling grant common to all UEs in a certain group (e.g. by using an RNTI common to the group, “poll RNTI”), all UEs in the group may transmit data/BSR if they have data in the buffer, otherwise they are silent (if the higher-layer parameter skipUplinkTxDynamic is set).

The resources upon which the UEs transmit can be preconfigured or derived from the UE identity (C-RNTI). For example, the resource blocks to use for transmission can be obtained as “(LSBs of C-RNTI)+(configurable RB offset)”. More generally, the resources may be based on a function of information contained in the C-RNTI, or another UE identity, like a RNTI, in particular a C-RNTI. In one case, all UEs within a group may use the same resources (assuming there are few users in a group and collisions are infrequent). The transmission would then have to contain a user identity (e.g. C-RNTI or derived thereof, or another user identity)), e.g. either explicitly as payload or implicitly, e.g. via scrambling, to identify the UE associated with the transmission. Users could potentially also be identified via their DM-RS, if different UEs in the group have different DM-RS (pattern and/or sequence) assigned to them, e.g. according to configuration by the network node/gNB.

### Example 3

To avoid dynamically sending grants to UEs (or groups of UEs), each UE can be preconfigured with resources sufficient for some data and a BSR. In essence this may be considered a “fat SR on PUSCH” compared to a small single-bit scheduling request on PUCCH. When such a resource occurs (in time), the UE can transmit BSR/data (if any) according to the grant. The gNB may have configured the (e.g., different) PUSCH resources for the different UEs and may, e.g., based on knowledge of the best reception beam for each UE, receive using the appropriate reception beam when such a resource occurs.

Multiple UEs (residing within, and/or covered by, the same reception beam) may be configured with PUSCH resources occurring during the time duration when a beam points into the same direction. To differentiate these UEs and avoid interference between them, different UEs can be configured with different time-frequency-domain resources. Alternatively, the time-frequency-domain resources can be derived from some other quantity or identity, such as the C-RNTI, or other RNTI. The DM-RS pattern and sequence a certain UE is using can also be tied to the C-RNTI in which it can be possible to separate UEs transmitting on the same time-frequency domain resources at the same time but with different DM-RS patterns. If UEs are assigned the same time-frequency resources, a UE identity (either implicit or explicit) may be utilised to identify the user if this cannot be done via DM-RS.

To handle UE movements, where the best reception beam changes, the gNB may be adapted to update the time-domain (and possibly frequency-domain) resources for autonomous PUSCH transmission such that the PUSCH transmission time is aligned with the gNB receiver beam pointing to the UE. Such updating can be done using existing beam management measurements. Alternatively, it is possible to link time-domain resources (e.g., when PUSCH transmission is allowed to occur) to the best received SSB (or best received CSI-RS among a set of configured CSI-RS, or some other downlink signal/reference signal). In this case, the UE may monitor the received signal strength (or signal quality) among a set of known/configured SSB occasions (or CSI-RS occasions), and may use a mapping function from the best received SSB (or CSI-RS) to a corresponding PUSCH transmission instant. This relation is known to both the UE and the gNB and the gNB can therefore sweep the reception beam in the same manner as the beam used to transmit the SSB (or CSI-RS) was swept. The same approach could also be used for PUCCH.

This may be implemented with a single configured grant, where the time instance when the grant is valid is tied to, and/or based on and/or associated to, the best SSB/CSI-RS. Alternatively, a UE may be configured with multiple configured grants, and based on the SSB/CSI-RS, e.g. an index thereof, one of the configurations is selected. Instead of best SSB/CSI-RS the UE can also use the SSB/CSI-RS indicated by the gNB to use.

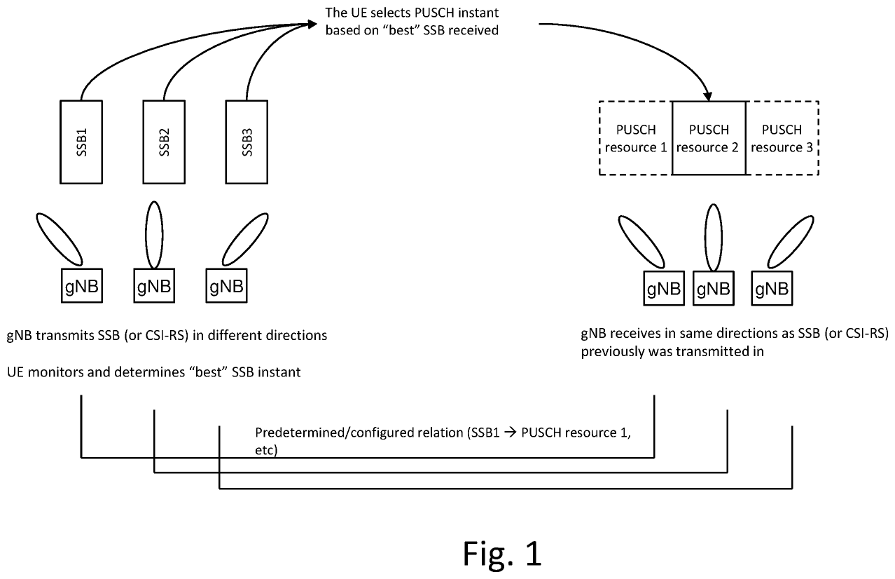

FIG. 1 shows an example of an uplink signaling scenario, in which a PUSCH transmission instant is determined based on best received SSB (or CSI-RS). There may be generally be a mapping (e.g., a predetermined relation) between reference signaling received, and/or timing and/or resources of reference signaling received, and an uplink signaling transmission timing and/or a reception beam timing. The mapping may be configured or configurable, and/or be predefined. As can be seen, a gNB transmits SSB in different directions. The different transmissions of SSB may be distinguishable, e.g. implicitly or explicitly, e.g. based on a numbering and/or signaling pattern and/or timing. A UE may receive one or more of the SSBs, and determined the best SSB. To each SSB, there may be associated a beam, e.g. represented by shape and/or direction and/or number and/or beam indication, which may be configured or configurable, and/or be predefined. A timing of reception beams (from the gNB) may be associated (e.g., based on a mapping) to the best SSB detected. The UE may transmit on an associated PUSCH resource (or PUCCH resource). The gNB may configure the SSB and/or uplink transmission resources accordingly, and/or be configured to receive signaling from the UE at one of the configured uplink transmission resources. The uplink signaling may be data signaling and/or BSR signaling, e.g. on PUSCH, or signaling on PUCCH, e.g. a SR. The resources for uplink signaling (PUSCH or PUCCH, e.g.) may be considered to be based on an UL TX configuration. The beams used by the gNB (in particular, the reception beams associated to the resources for UL TX configuration) may be considered to represent a reception beam configuration.

### Example 4

Alternatively, or additionally, a scheduling request on the PUCCH may be used. To speed up the beam sweeping, the PUCCH may be given a structure such that it is possible to decode the PUCCH even if only a part of the PUCCH is received. For example, a PUCCH format with a long PUCCH spanning a full slot may used, wherein the presence/absence of SR may be detected or detectable based on observing only a small number L of symbol time intervals, e.g. one or two symbol time intervals, e.g. two OFDM symbols. Alternatively, the UE may be configured to repeat a short PUCCH multiple time instants to enable the gNB to sweep the reception beam. The UE may be allowed to transmit multiple SR without awaiting feedback from the gNB in order to enable fast SR transmissions in multiple directions, such that independent of feedback from the network, the UE may transmit the PUCCH multiple times.

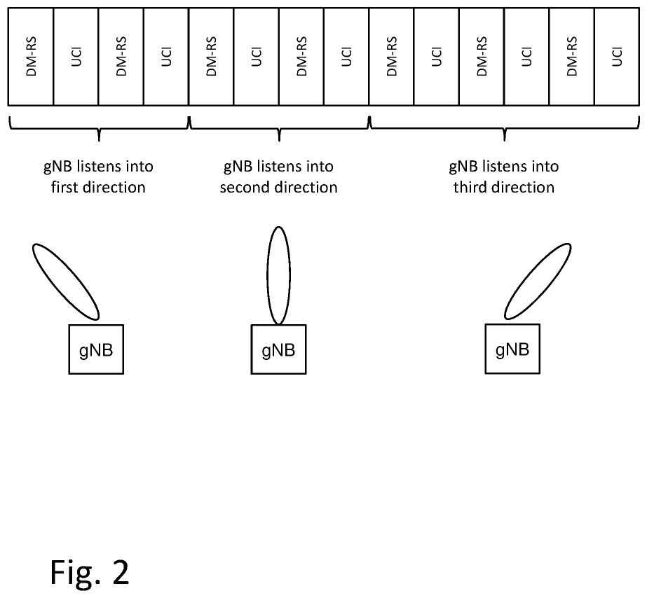

FIG. 2 shows another example of uplink signaling. In FIG. 2, beam sweeping with a special PUCCH format is shown. A UE may transmit a long PUCCH format, which may cover a plurality of N symbol time intervals, wherein N may be larger than 7. In FIG. 2, N=14 is shown. The PUCCH format may comprise DM-RS and UCI, wherein the UCI may represent the scheduling request. The gNB may be adapted to identify the PUCCH format from partially listening in (e.g., with the second beam), e.g. from the DMRS and/or UCI pattern and/or resources used and/or sequence. In particular, a format in which a (or all) symbols carrying DMRS is followed and/or preceded by a symbol carrying UCI, and/or vice versa, may be considered.

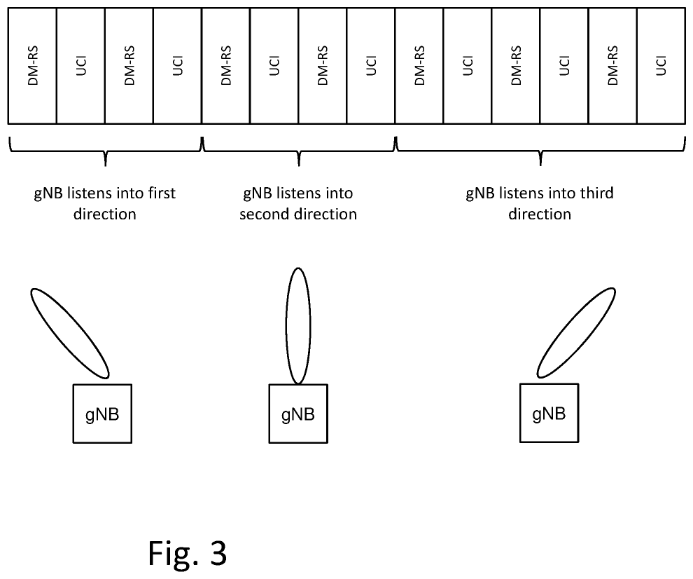

FIG. 3 shows an exemplary scenario for uplink transmission in which beam sweeping with multiple repetitions of a short PUCCH may be performed. The gNB may perform the beam sweeping for a reception beam, whereas the UE may transmit multiple transmissions of a short PUCCH format (e.g., carrying a SR, e.g. 1-bit) on different PUCCH resources, which in this example may be continuous in time, each resource neighboring at least one other resource. More or fewer than 7 transmissions (6 repetitions) may be used.

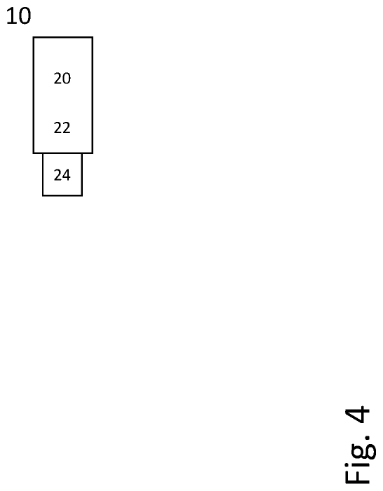

FIG. 4 schematically shows a radio node, in particular a terminal or wireless device 10, which may in particular be implemented as a UE (User Equipment). Radio node 10 comprises processing circuitry (which may also be referred to as control circuitry) 20, which may comprise a controller connected to a memory. Any module of the radio node 10, e.g. a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals. Radio circuitry 22 and the processing circuitry 20 controlling it are configured for cellular communication with a network, e.g. a RAN as described herein, and/or for sidelink communication. Radio node 10 may generally be adapted to carry out any of the methods of operating a radio node like terminal or UE disclosed herein; in particular, it may comprise corresponding circuitry, e.g. processing circuitry, and/or modules.

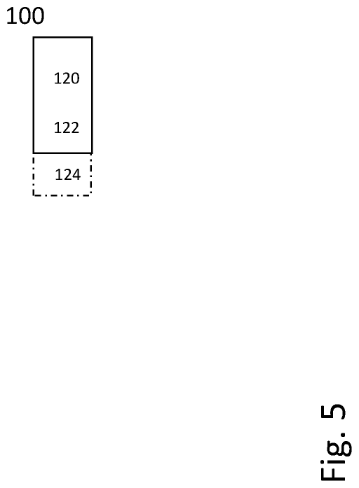

FIG. 5 schematically show a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g. transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g. processing circuitry, and/or modules. The antenna circuitry 124 may be connected to and/or comprise an antenna array. The node 100, respectively its circuitry, may be adapted to perform any of the methods of operating a network node or a radio node as described herein; in particular, it may comprise corresponding circuitry, e.g. processing circuitry, and/or modules. The radio node 100 may generally comprise communication circuitry, e.g. for communication with another network node, like a radio node, and/or with a core network and/or an internet or local net, in particular with an information system, which may provide information and/or data to be transmitted to a user equipment.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, is described. The system may be a wireless communication system, and/or provide and/or represent a radio access network.

Moreover, there may be generally considered a method of operating an information system, the method comprising providing information. Alternatively, or additionally, an information system adapted for providing information may be considered. Providing information may comprise providing information for, and/or to, a target system, which may comprise and/or be implemented as radio access network and/or a radio node, in particular a network node or user equipment or terminal. Providing information may comprise transferring and/or streaming and/or sending and/or passing on the information, and/or offering the information for such and/or for download, and/or triggering such providing, e.g. by triggering a different system or node to stream and/or transfer and/or send and/or pass on the information. The information system may comprise, and/or be connected or connectable to, a target, for example via one or more intermediate systems, e.g. a core network and/or internet and/or private or local network. Information may be provided utilising and/or via such intermediate system/s. Providing information may be for radio transmission and/or for transmission via an air interface and/or utilising a RAN or radio node as described herein. Connecting the information system to a target, and/or providing information, may be based on a target indication, and/or adaptive to a target indication. A target indication may indicate the target, and/or one or more parameters of transmission pertaining to the target and/or the paths or connections over which the information is provided to the target. Such parameter/s may in particular pertain to the air interface and/or radio access network and/or radio node and/or network node. Example parameters may indicate for example type and/or nature of the target, and/or transmission capacity (e.g., data rate) and/or latency and/or reliability and/or cost, respectively one or more estimates thereof. The target indication may be provided by the target, or determined by the information system, e.g. based on information received from the target and/or historical information, and/or be provided by a user, for example a user operating the target or a device in communication with the target, e.g. via the RAN and/or air interface. For example, a user may indicate on a user equipment communicating with the information system that information is to be provided via a RAN, e.g. by selecting from a selection provided by the information system, for example on a user application or user interface, which may be a web interface. An information system may comprise one or more information nodes. An information node may generally comprise processing circuitry and/or communication circuitry. In particular, an information system and/or an information node may be implemented as a computer and/or a computer arrangement, e.g. a host computer or host computer arrangement and/or server or server arrangement. In some variants, an interaction server (e.g., web server) of the information system may provide a user interface, and based on user input may trigger transmitting and/or streaming information provision to the user (and/or the target) from another server, which may be connected or connectable to the interaction server and/or be part of the information system or be connected or connectable thereto. The information may be any kind of data, in particular data intended for a user of for use at a terminal, e.g. video data and/or audio data and/or location data and/or interactive data and/or game-related data and/or environmental data and/or technical data and/or traffic data and/or vehicular data and/or circumstantial data and/or operational data. The information provided by the information system may be mapped to, and/or mappable to, and/or be intended for mapping to, communication or data signaling and/or one or more data channels as described herein (which may be signaling or channel/s of an air interface and/or used within a RAN and/or for radio transmission). It may be considered that the information is formatted based on the target indication and/or target, e.g. regarding data amount and/or data rate and/or data structure and/or timing, which in particular may be pertaining to a mapping to communication or data signaling and/or a data channel. Mapping information to data signaling and/or data channel/s may be considered to refer to using the signaling/channel/s to carry the data, e.g. on higher layers of communication, with the signaling/channel/s underlying the transmission. A target indication generally may comprise different components, which may have different sources, and/or which may indicate different characteristics of the target and/or communication path/s thereto. A format of information may be specifically selected, e.g. from a set of different formats, for information to be transmitted on an air interface and/or by a RAN as described herein. This may be particularly pertinent since an air interface may be limited in terms of capacity and/or of predictability, and/or potentially be cost sensitive. The format may be selected to be adapted to the transmission indication, which may in particular indicate that a RAN or radio node as described herein is in the path (which may be the indicated and/or planned and/or expected path) of information between the target and the information system. A (communication) path of information may represent the interface/s (e.g., air and/or cable interfaces) and/or the intermediate system/s (if any), between the information system and/or the node providing or transferring the information, and the target, over which the information is, or is to be, passed on. A path may be (at least partly) undetermined when a target indication is provided, and/or the information is provided/transferred by the information system, e.g. if an internet is involved, which may comprise multiple, dynamically chosen paths. Information and/or a format used for information may be packet-based, and/or be mapped, and/or be mappable and/or be intended for mapping, to packets. Alternatively, or additionally, there may be considered a method for operating a target device comprising providing a target indicating to an information system. More alternatively, or additionally, a target device may be considered, the target device being adapted for providing a target indication to an information system. In another approach, there may be considered a target indication tool adapted for, and/or comprising an indication module for, providing a target indication to an information system. The target device may generally be a target as described above. A target indication tool may comprise, and/or be implemented as, software and/or application or app, and/or web interface or user interface, and/or may comprise one or more modules for implementing actions performed and/or controlled by the tool. The tool and/or target device may be adapted for, and/or the method may comprise, receiving a user input, based on which a target indicating may be determined and/or provided. Alternatively, or additionally, the tool and/or target device may be adapted for, and/or the method may comprise, receiving information and/or communication signaling carrying information, and/or operating on, and/or presenting (e.g., on a screen and/or as audio or as other form of indication), information. The information may be based on received information and/or communication signaling carrying information. Presenting information may comprise processing received information, e.g. decoding and/or transforming, in particular between different formats, and/or for hardware used for presenting. Operating on information may be independent of or without presenting, and/or proceed or succeed presenting, and/or may be without user interaction or even user reception, for example for automatic processes, or target devices without (e.g., regular) user interaction like MTC devices, of for automotive or transport or industrial use. The information or communication signaling may be expected and/or received based on the target indication. Presenting and/or operating on information may generally comprise one or more processing steps, in particular decoding and/or executing and/or interpreting and/or transforming information. Operating on information may generally comprise relaying and/or transmitting the information, e.g. on an air interface, which may include mapping the information onto signaling (such mapping may generally pertain to one or more layers, e.g. one or more layers of an air interface, e.g. RLC (Radio Link Control) layer and/or MAC layer and/or physical layer/s). The information may be imprinted (or mapped) on communication signaling based on the target indication, which may make it particularly suitable for use in a RAN (e.g., for a target device like a network node or in particular a UE or terminal). The tool may generally be adapted for use on a target device, like a UE or terminal. Generally, the tool may provide multiple functionalities, e.g. for providing and/or selecting the target indication, and/or presenting, e.g. video and/or audio, and/or operating on and/or storing received information. Providing a target indication may comprise transmitting or transferring the indication as signaling, and/or carried on signaling, in a RAN, for example if the target device is a UE, or the tool for a UE. It should be noted that such provided information may be transferred to the information system via one or more additionally communication interfaces and/or paths and/or connections. The target indication may be a higher-layer indication and/or the information provided by the information system may be higher-layer information, e.g. application layer or user-layer, in particular above radio layers like transport layer and physical layer. The target indication may be mapped on physical layer radio signaling, e.g. related to or on the user-plane, and/or the information may be mapped on physical layer radio communication signaling, e.g. related to or on the user-plane (in particular, in reverse communication directions). The described approaches allow a target indication to be provided, facilitating information to be provided in a specific format particularly suitable and/or adapted to efficiently use an air interface. A user input may for example represent a selection from a plurality of possible transmission modes or formats, and/or paths, e.g. in terms of data rate and/or packaging and/or size of information to be provided by the information system.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Reference signaling may be signaling comprising one or more reference symbols and/or structures. Reference signaling may be adapted for gauging and/or estimating and/or representing transmission conditions, e.g. channel conditions and/or transmission path conditions and/or channel (or signal or transmission) quality. It may be considered that the transmission characteristics (e.g., signal strength and/or form and/or modulation and/or timing) of reference signaling are available for both transmitter and receiver of the signaling (e.g., due to being predefined and/or configured or configurable and/or being communicated). Different types of reference signaling may be considered, e.g. pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g. power-related or energy-related or amplitude-related (e.g., SRS or pilot signaling) and/or phase-related, etc. An antenna arrangement may comprise one or more antenna elements (radiating elements), which may be combined in antenna arrays. An antenna array or subarray may comprise one antenna element, or a plurality of antenna elements, which may be arranged e.g. two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangement associated to a UE or terminal may be smaller (e.g., in size and/or number of antenna elements or arrays) than the antenna arrangement associated to a network node. Antenna elements of an antenna arrangement may be configurable for different arrays, e.g. to change the beamforming characteristics. In particular, antenna arrays may be formed by combining one or more independently or separately controllable antenna elements or subarrays. The beams may be provided by analog beamforming, or in some variants by digital beamforming. The informing radio nodes may be configured with the manner of beam transmission, e.g. by transmitting a corresponding indicator or indication, for example as beam identify indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) to convert digital control information into an analog antenna feed for the whole antenna arrangement (the ADC may be considered part of, and/or connected or connectable to, antenna circuitry). A scenario in which each antenna element is individually controllable may be referred to as digital beamforming, whereas a scenario in which larger arrays/subarrays are separately controllable may be considered an example of analog beamforming. Alternatively, or additionally analog beamforming may correspond to systems and/or scenarios in which the beam is formed in the analog domain, in particular after digital-to-analog conversion. Digital beamforming, may correspond to systems and/or scenarios in which the beam is formed in the digital domain, in particular before digital-to-analog conversion, in case of a multi-carrier system possibly even in frequency-domain. Digital beamforming allows for a large or arbitrary number of beams and beam shapes at a time and multiplexing of different UEs can take place in both the time and frequency domains (since at one time instant different beams associated with different frequencies can be generated). Analog beamforming may be limited to one beam at a time. Hybrid forms may be considered.

Uplink or sidelink signaling may be OFDMA (Orthogonal Frequency Division Multiple Access) or SC-FDMA (Single Carrier Frequency Division Multiple Access) signaling. Downlink signaling may in particular be OFDMA signaling. However, signaling is not limited thereto (Filter-Bank based signaling may be considered one alternative).

A radio node may generally be considered a device or node adapted for wireless and/or radio (and/or microwave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or IAB node and/or other node, in particular for a RAN as described herein.

The terms wireless device, user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, an RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A radio access network may be a wireless communication network, and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Control information or a control information message or corresponding signaling (control signaling) may be transmitted on a control channel, e.g. a physical control channel, which may be a downlink channel or (or a sidelink channel in some cases, e.g. one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signaling, e.g. as a form of control information or signaling like uplink control information/signaling, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signaling.

Signaling may generally be considered to represent an electromagnetic wave structure (e.g., over a time interval and frequency interval), which is intended to convey information to at least one specific or generic (e.g., anyone who might pick up the signaling) target. A process of signaling may comprise transmitting the signaling. Transmitting signaling, in particular control signaling or communication signaling, e.g. comprising or representing acknowledgement signaling and/or resource requesting information, may comprise encoding and/or modulating. Encoding and/or modulating may comprise error detection coding and/or forward error correction encoding and/or scrambling. Receiving control signaling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction. Coded bits may refer to information bits (also called systematic bits) plus coding bits.

Communication signaling may comprise, and/or represent, and/or be implemented as, data signaling, and/or user plane signaling. Communication signaling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signaling may be signaling associated to and/or on a data channel.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signaling as described herein, based on the utilised resource sequence, implicitly indicates the control signaling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signaling, e.g. according to a specific format, may be communicated, for example transmitted and/or received, and/or be intended for transmission and/or reception.

A border symbol may generally represent a starting symbol or an ending symbol for transmitting and/or receiving. A starting symbol may in particular be a starting symbol of uplink or sidelink signaling, for example control signaling or data signaling. Such signaling may be on a data channel or control channel, e.g. a physical channel, in particular a physical uplink shared channel (like PUSCH) or a sidelink data or shared channel, or a physical uplink control channel (like PUCCH) or a sidelink control channel. If the starting symbol is associated to control signaling (e.g., on a control channel), the control signaling may be in response to received signaling (in sidelink or downlink), e.g. representing acknowledgement signaling associated thereto, which may be HARQ or ARQ signaling. An ending symbol may represent an ending symbol (in time) of downlink or sidelink transmission or signaling, which may be intended or scheduled for the radio node or user equipment. Such downlink signaling may in particular be data signaling, e.g. on a physical downlink channel like a shared channel, e.g. a PDSCH (Physical Downlink Shared Channel). A starting symbol may be determined based on, and/or in relation to, such an ending symbol.

Configuring a radio node, in particular a terminal or user equipment, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilise, and/or be adapted to utilise, its circuitry/ies for configuring. Allocation information may be considered a form of configuration data. Configuration data may comprise and/or be represented by configuration information, and/or one or more corresponding indications and/or message/s

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor.

A resource structure may be considered to be neighbored in frequency domain by another resource structure, if they share a common border frequency, e.g. one as an upper frequency border and the other as a lower frequency border. Such a border may for example be represented by the upper end of a bandwidth assigned to a subcarrier n, which also represents the lower end of a bandwidth assigned to a subcarrier n+1. A resource structure may be considered to be neighbored in time domain by another resource structure, if they share a common border time, e.g. one as an upper (or right in the figures) border and the other as a lower (or left in the figures) border. Such a border may for example be represented by the end of the symbol time interval assigned to a symbol n, which also represents the beginning of a symbol time interval assigned to a symbol n+1.

Generally, a resource structure being neighbored by another resource structure in a domain may also be referred to as abutting and/or bordering the other resource structure in the domain.

A resource structure may general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of subcarrier/s. A resource element may be considered an example for a resource structure, a slot or mini-slot or a Physical Resource Block (PRB) or parts thereof may be considered others. A resource structure may be associated to a specific channel, e.g. a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g. due to circuitry and/or configuration and/or regulations and/or a standard. A bandwidth part may be configured or configurable to a radio node. In some variants, a bandwidth part may be the part of a bandwidth used for communicating, e.g. transmitting and/or receiving, by a radio node. The bandwidth part may be smaller than the bandwidth (which may be a device bandwidth defined by the circuitry/configuration of a device, and/or a system bandwidth, e.g. available for a RAN). It may be considered that a bandwidth part comprises one or more resource blocks or resource block groups, in particular one or more PRBs or PRB groups. A bandwidth part may pertain to, and/or comprise, one or more carriers.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval). Different carriers may be non-overlapping, and/or may be neighboring in frequency domain.

It should be noted that the term “radio” in this disclosure may be considered to pertain to wireless communication in general, and may also include wireless communication utilising microwave and/or millimeter and/or other frequencies, in particular between 100 MHz or 1 GHz, and 100 GHz or 20 or 10 GHz. Such communication may utilise one or more carriers.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on an LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction. Examples of channels comprise a channel for low latency and/or high reliability transmission, in particular a channel for Ultra-Reliable Low Latency Communication (URLLC), which may be for control and/or data.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In particular, numerologies with different subcarrier spacings may have different symbol time length. Generally, a symbol time length may be based on, and/or include, a guard time interval or cyclic extension, e.g. prefix or postfix.

A sidelink may generally represent a communication channel (or channel structure) between two UEs and/or terminals, in which data is transmitted between the participants (UEs and/or terminals) via the communication channel, e.g. directly and/or without being relayed via a network node. A sidelink may be established only and/or directly via air interface/s of the participant, which may be directly linked via the sidelink communication channel. In some variants, sidelink communication may be performed without interaction by a network node, e.g. on fixedly defined resources and/or on resources negotiated between the participants. Alternatively, or additionally, it may be considered that a network node provides some control functionality, e.g. by configuring resources, in particular one or more resource pool/s, for sidelink communication, and/or monitoring a sidelink, e.g. for charging purposes.

Sidelink communication may also be referred to as device-to-device (D2D) communication, and/or in some cases as ProSe (Proximity Services) communication, e.g. in the context of LTE. A sidelink may be implemented in the context of V2x communication (Vehicular communication), e.g. V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g. a PSCCH (Physical Sidelink Control CHannel, which may for example carry control information like an acknowledgement position indication, and/or a PSSCH (Physical Sidelink Shared CHannel, which for example may carry data and/or acknowledgement signaling). It may be considered that a sidelink communication channel (or structure) pertains to and/or used one or more carrier/s and/or frequency range/s associated to, and/or being used by, cellular communication, e.g. according to a specific license and/or standard. Participants may share a (physical) channel and/or resources, in particular in frequency domain and/or related to a frequency resource like a carrier) of a sidelink, such that two or more participants transmit thereon, e.g. simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g. an LTE-based standard and/or NR. A sidelink may utilise TDD (Time Division Duplex) and/or FDD (Frequency Division Duplex) technology, e.g. as configured by a network node, and/or preconfigured and/or negotiated between the participants. A user equipment may be considered to be adapted for sidelink communication if it, and/or its radio circuitry and/or processing circuitry, is adapted for utilising a sidelink, e.g. on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signaling. Communication on a sidelink (or sidelink signaling) may comprise utilising the sidelink for communication (respectively, for signaling). Sidelink transmission and/or transmitting on a sidelink may be considered to comprise transmission utilising the sidelink, e.g. associated resources and/or transmission formats and/or circuitry and/or the air interface. Sidelink reception and/or receiving on a sidelink may be considered to comprise reception utilising the sidelink, e.g. associated resources and/or transmission formats and/or circuitry and/or the air interface. Sidelink control information (e.g., SCI) may generally be considered to comprise control information transmitted utilising a sidelink.

Generally, carrier aggregation (CA) may refer to the concept of a radio connection and/or communication link between a wireless and/or cellular communication network and/or network node and a terminal or on a sidelink comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. be referred to as primary component carrier or PCC), over which control information may be transmitted, wherein the control information may refer to the primary carrier and other carriers, which may be referred to as secondary carriers (or secondary component carrier, SCC). However, in some approaches, control information may be sent over more than one carrier of an aggregate, e.g. one or more PCCs and one PCC and one or more SCCs.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

A configuration or schedule, like a mini-slot configuration and/or structure configuration, may schedule transmissions, e.g. for the time/transmissions it is valid, and/or transmissions may be scheduled by separate signaling or separate configuration, e.g. separate RRC signaling and/or downlink control information signaling. The transmission/s scheduled may represent signaling to be transmitted by the device for which it is scheduled, or signaling to be received by the device for which it is scheduled, depending on which side of a communication the device is. It should be noted that downlink control information or specifically DCI signaling may be considered physical layer signaling, in contrast to higher layer signaling like MAC (Medium Access Control) signaling or RRC layer signaling. The higher the layer of signaling is, the less frequent/the more time/resource consuming it may be considered, at least partially due to the information contained in such signaling having to be passed on through several layers, each layer requiring processing and handling.

A scheduled transmission, and/or transmission timing structure like a mini-slot or slot, may pertain to a specific channel, in particular a physical uplink shared channel, a physical uplink control channel, or a physical downlink shared channel, e.g. PUSCH, PUCCH or PDSCH, and/or may pertain to a specific cell and/or carrier aggregation. A corresponding configuration, e.g. scheduling configuration or symbol configuration may pertain to such channel, cell and/or carrier aggregation. It may be considered that the scheduled transmission represents transmission on a physical channel, in particular a shared physical channel, for example a physical uplink shared channel or physical downlink shared channel. For such channels, semi-persistent configuring may be particularly suitable.

Generally, a configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

A control region of a transmission timing structure may be an interval in time for intended or scheduled or reserved for control signaling, in particular downlink control signaling, and/or for a specific control channel, e.g. a physical downlink control channel like PDCCH. The interval may comprise, and/or consist of, a number of symbols in time, which may be configured or configurable, e.g. by (UE-specific) dedicated signaling (which may be single-cast, for example addressed to or intended for a specific UE), e.g. on a PDCCH, or RRC signaling, or on a multicast or broadcast channel. In general, the transmission timing structure may comprise a control region covering a configurable number of symbols. It may be considered that in general the border symbol is configured to be after the control region in time.

The duration of a symbol (symbol time length or interval) of the transmission timing structure may generally be dependent on a numerology and/or carrier, wherein the numerology and/or carrier may be configurable. The numerology may be the numerology to be used for the scheduled transmission.

Scheduling a device, or for a device, and/or related transmission or signaling, may be considered comprising, or being a form of, configuring the device with resources, and/or of indicating to the device resources, e.g. to use for communicating. Scheduling may in particular pertain to a transmission timing structure, or a substructure thereof (e.g., a slot or a mini-slot, which may be considered a substructure of a slot). It may be considered that a border symbol may be identified and/or determined in relation to the transmission timing structure even if for a substructure being scheduled, e.g. if an underlying timing grid is defined based on the transmission timing structure. Signaling indicating scheduling may comprise corresponding scheduling information and/or be considered to represent or contain configuration data indicating the scheduled transmission and/or comprising scheduling information. Such configuration data or signaling may be considered a resource configuration or scheduling configuration. It should be noted that such a configuration (in particular as single message) in some cases may not be complete without other configuration data, e.g. configured with other signaling, e.g. higher layer signaling. In particular, the symbol configuration may be provided in addition to scheduling/resource configuration to identify exactly which symbols are assigned to a scheduled transmission. A scheduling (or resource) configuration may indicate transmission timing structure/s and/or resource amount (e.g., in number of symbols or length in time) for a scheduled transmission.

A scheduled transmission may be transmission scheduled, e.g. by the network or network node. Transmission may in this context may be uplink (UL) or downlink (DL) or sidelink (SL) transmission. A device, e.g. a user equipment, for which the scheduled transmission is scheduled, may accordingly be scheduled to receive (e.g., in DL or SL), or to transmit (e.g. in UL or SL) the scheduled transmission. Scheduling transmission may in particular be considered to comprise configuring a scheduled device with resource/s for this transmission, and/or informing the device that the transmission is intended and/or scheduled for some resources. A transmission may be scheduled to cover a time interval, in particular a successive number of symbols, which may form a continuous interval in time between (and including) a starting symbol and an ending symbol. The starting symbol and the ending symbol of a (e.g., scheduled) transmission may be within the same transmission timing structure, e.g. the same slot. However, in some cases, the ending symbol may be in a later transmission timing structure than the starting symbol, in particular a structure following in time. To a scheduled transmission, a duration may be associated and/or indicated, e.g. in a number of symbols or associated time intervals. In some variants, there may be different transmissions scheduled in the same transmission timing structure. A scheduled transmission may be considered to be associated to a specific channel, e.g. a shared channel like PUSCH or PDSCH.

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g. one or more transmission timing structures like slots or slot aggregations, and/or for one or more (e.g., specific number) of transmission/occurrences. Dynamic configuration may be based on low-level signaling, e.g. control signaling on the physical layer and/or MAC layer, in particular in the form of DCI or SCI. Periodic/semi-static may pertain to longer timescales, e.g. several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signaling, in particular RCL layer signaling and/or RRC signaling and/or MAC signaling.

A transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

Feedback signaling may be considered a form or control signaling, e.g. uplink or sidelink control signaling, like UCI (Uplink Control Information) signaling or SCI (Sidelink Control Information) signaling. Feedback signaling may in particular comprise and/or represent acknowledgement signaling and/or acknowledgement information and/or measurement reporting.

Acknowledgement information may comprise an indication of a specific value or state for an acknowledgement signaling process, e.g. ACK or NACK or DTX. Such an indication may for example represent a bit or bit value or bit pattern or an information switch. Different levels of acknowledgement information, e.g. providing differentiated information about quality of reception and/or error position in received data element/s may be considered and/or represented by control signaling. Acknowledgment information may generally indicate acknowledgment or non-acknowledgment or non-reception or different levels thereof, e.g. representing ACK or NACK or DTX. Acknowledgment information may pertain to one acknowledgement signaling process. Acknowledgement signaling may comprise acknowledgement information pertaining to one or more acknowledgement signaling processes, in particular one or more HARQ or ARQ processes. It may be considered that to each acknowledgment signaling process the acknowledgement information pertains to, a specific number of bits of the information size of the control signaling is assigned. Measurement reporting signaling may comprise measurement information.

Signaling may generally comprise one or more symbols and/or signals and/or messages. A signal may comprise and/or represent one or more bits, which may be modulated into a common modulated signal. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different acknowledgement signaling processes, e.g. representing and/or pertaining to one or more such processes. An indication may comprise signaling and/or a plurality of signals and/or messages and/or may be comprised therein, which may be transmitted on different carriers and/or be associated to different acknowledgement signaling processes, e.g. representing and/or pertaining to one or more such processes.

Signaling utilising, and/or on and/or associated to, resources or a resource structure may be signaling covering the resources or structure, signaling on the associated frequency/ies and/or in the associated time interval/s. It may be considered that a signaling resource structure comprises and/or encompasses one or more substructures, which may be associated to one or more different channels and/or types of signaling and/or comprise one or more holes (resource element/s not scheduled for transmissions or reception of transmissions). A resource substructure, e.g. a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g. time and/or frequency. The resource elements of a substructure may be scheduled for associated signaling.

It should generally be noted that the number of bits or a bit rate associated to specific signaling that can be carried on a resource element may be based on a modulation and coding scheme (MCS). Thus, bits or a bit rate may be seen as a form of resources representing a resource structure or range in frequency and/or time, e.g. depending on MCS. The MCS may be configured or configurable, e.g. by control signaling, e.g. DCI or MAC (Medium Access Control) or RRC (Radio Resource Control) signaling.

Different formats of for control information may be considered, e.g. different formats for a control channel like a Physical Uplink Control Channel (PUCCH). PUCCH may carry control information or corresponding control signaling, e.g. Uplink Control Information (UCI). UCI may comprise feedback signaling, and/or acknowledgement signaling like HARQ feedback (ACK/NACK), and/or measurement information signaling, e.g. comprising Channel Quality Information (CQI), and/or Scheduling Request (SR) signaling. One of the supported PUCCH formats may be short, and may e.g. occur at the end of a slot interval, and/or multiplexed and/or neighboring to PUSCH. Similar control information may be provided on a sidelink, e.g. as Sidelink Control Information (SCI), in particular on a (physical) sidelink control channel, like a (P)SCCH.

A code block may be considered a subelement of a data element like a transport block, e.g., a transport block may comprise a one or a plurality of code blocks.

A scheduling assignment may be configured with control signaling, e.g. downlink control signaling or sidelink control signaling. Such controls signaling may be considered to represent and/or comprise scheduling signaling, which may indicate scheduling information. A scheduling assignment may be considered scheduling information indicating scheduling of signaling/transmission of signaling, in particular pertaining to signaling received or to be received by the device configured with the scheduling assignment. It may be considered that a scheduling assignment may indicate data (e.g., data block or element and/or channel and/or data stream) and/or an (associated) acknowledgement signaling process and/or resource/s on which the data (or, in some cases, reference signaling) is to be received and/or indicate resource/s for associated feedback signaling, and/or a feedback resource range on which associated feedback signaling is to be transmitted. Transmission associated to an acknowledgement signaling process, and/or the associated resources or resource structure, may be configured and/or scheduled, for example by a scheduling assignment. Different scheduling assignments may be associated to different acknowledgement signaling processes. A scheduling assignment may be considered an example of downlink control information or signaling, e.g. if transmitted by a network node and/or provided on downlink (or sidelink control information if transmitted using a sidelink and/or by a user equipment).

A scheduling grant (e.g., uplink grant) may represent control signaling (e.g., downlink control information/signaling). It may be considered that a scheduling grant configures the signaling resource range and/or resources for uplink (or sidelink) signaling, in particular uplink control signaling and/or feedback signaling, e.g. acknowledgement signaling. Configuring the signaling resource range and/or resources may comprise configuring or scheduling it for transmission by the configured radio node. A scheduling grant may indicate a channel and/or possible channels to be used/usable for the feedback signaling, in particular whether a shared channel like a PUSCH may be used/is to be used. A scheduling grant may generally indicate uplink resource/s and/or an uplink channel and/or a format for control information pertaining to associated scheduling assignments. Both grant and assignment/s may be considered (downlink or sidelink) control information, and/or be associated to, and/or transmitted with, different messages.

A resource structure in frequency domain (which may be referred to as frequency interval and/or range) may be represented by a subcarrier grouping. A subcarrier grouping may comprise one or more subcarriers, each of which may represent a specific frequency interval, and/or bandwidth. The bandwidth of a subcarrier, the length of the interval in frequency domain, may be determined by the subcarrier spacing and/or numerology. The subcarriers may be arranged such that each subcarrier neighbours at least one other subcarrier of the grouping in frequency space (for grouping sizes larger than 1). The subcarriers of a grouping may be associated to the same carrier, e.g. configurably or configured of predefined. A physical resource block may be considered representative of a grouping (in frequency domain). A subcarrier grouping may be considered to be associated to a specific channel and/or type of signaling, if transmission for such channel or signaling is scheduled and/or transmitted and/or intended and/or configured for at least one, or a plurality, or all subcarriers in the grouping. Such association may be time-dependent, e.g. configured or configurable or predefined, and/or dynamic or semi-static. The association may be different for different devices, e.g. configured or configurable or predefined, and/or dynamic or semi-static. Patterns of subcarrier groupings may be considered, which may comprise one or more subcarrier groupings (which may be associated to same or different signalings/channels), and/or one or more groupings without associated signaling (e.g., as seen from a specific device). An example of a pattern is a comb, for which between pairs of groupings associated to the same signaling/channel there are arranged one or more groupings associated to one or more different channels and/or signaling types, and/or one or more groupings without associated channel/signaling).

A search space may represent resources to monitor for signaling, e.g. time/frequency and/or code resources. A search space may be associated to a one or more specific channels, e.g. control or data channels, and/or one or more radio nodes and/or radio identities, e.g. RNTIs, and/or one or more specific signaling formats, e.g. DCI or PDCCH formats. A search space may be configured to a UE by a network node, e.g. dynamically and/or semi-statically, e.g. with DCI signaling and/or RRC signaling. A UE may be configured with multiple search spaces. A radio node may expect to receive, and/or monitor for, specific types of signaling associated to a search space in the search space, for example PDCCH signaling in an associated search space. Different types and/or formats of PDCCH signaling (e.g. DCI formats) may be associated to the same or different search spaces. A UE-specific search space may be a search space configured to a UE, e.g. for a (or for more than one UE-specific RNTI). A common search space may be a search space configured for a plurality of UEs, and/or for a group identity (e.g., group RNTI), or without specific or group identity. Multiple UEs may expect reception of control signaling like DCI in a common search space. It may be considered that UE-specific signaling is transmitted with a UE-specific identifier in a common search space, e.g. such that only one of the multiple UEs monitoring the CSS is able to correctly receive the signaling. A search space of a UE may in particular be associated to reception of downlink signaling, in particular control signaling, e.g. control signaling on PDCCH. A search space of a network node may in particular be associated to reception of uplink signaling like PUCCH signaling or PUSCH signaling.

In general, radio signaling requires time to cover distances, such that between transmission and reception of signaling there will be a delay, which may be depended on multi-path effects and/or reflections. A network node may be adapted to be aware of such delays and may consider them, e.g. when scheduling and/or configuring a UE with a timing correction, e.g. a timing advance and/or timing advance correction. In general, resource for transmission and reception of the same signaling may be considered to be shifted in time for accommodating the time delay.

Example types of signaling comprise signaling of a specific communication direction, in particular, uplink signaling, downlink signaling, sidelink signaling, as well as reference signaling (e.g., SRS or CRS or CSI-RS), communication signaling, control signaling, and/or signaling associated to a specific channel like PUSCH, PDSCH, PUCCH, PDCCH, PSCCH, PSSCH, etc.).

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM). While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

Some useful abbreviations comprise

| Abbreviation | Explanation |
|---|---|
| ACK/NACK | Acknowledgment/Negative Acknowledgement |
| ARQ | Automatic Repeat reQuest |
| CAZAC | Constant Amplitude Zero Cross Correlation |
| CBG | Code Block Group |
| CDM | Code Division Multiplex |
| CM | Cubic Metric |
| CQI | Channel Quality Information |
| CRC | Cyclic Redundancy Check |
| CRS | Common reference signal |
| CSI | Channel State Information |
| CSI-RS | Channel state information reference signal |
| CSS | Common Search Space |
| DAI | Downlink Assignment Indicator |
| DCI | Downlink Control Information |
| DFT | Discrete Fourier Transform |
| DM(-)RS | Demodulation reference signal(ing) |
| FDM | Frequency Division Multiplex |
| HARQ | Hybrid Automatic Repeat Request |
| IAB | Integrated Access and Backhaul |
| IFFT | Inverse Fast Fourier Transform |
| LSB | Least Significant Bit |
| MBB | Mobile Broadband |
| MCS | Modulation and Coding Scheme |
| MIMO | Multiple-input-multiple-output |
| MRC | Maximum-ratio combining |
| MRT | Maximum-ratio transmission |
| MSB | Most Significant Bit |
| MU-MIMO | Multiuser multiple-input-multiple-output |
| OFDM/A | Orthogonal Frequency Division |
| | Multiplex/Multiple Access |
| PAPR | Peak to Average Power Ratio |
| PBCH | Physical Broadcast CHannel |
| PDCCH | Physical Downlink Control CHannel |
| PDSCH | Physical Downlink Shared CHannel |
| PRACH | Physical Random Access CHannel |
| PRB | Physical Resource Block |
| PUCCH | Physical Uplink Control CHannel |
| PUSCH | Physical Uplink Shared CHannel |
| (P)SCCH | (Physical) Sidelink Control CHannel |
| (P)SSCH | (Physical) Sidelink Shared CHannel |
| RB | Resource Block |
| RNTI | Radio Network Temporary Identifier |
| RRC | Radio Resource Control |
| RX | Receiver, receiver-side |
| SC-FDM/A | Single Carrier Frequency Division |
| | Multiplex/Multiple Access |
| SCI | Sidelink Control Information |
| SI | System Information (high-level information, |
| | e.g. cell-specific) |
| SINR | Signal-to-interference-plus-noise ratio |
| SIR | Signal-to-interference ratio |
| SNR | Signal-to-noise-ratio |
| SR | Scheduling Request |
| SRS | Sounding Reference Signal(ing) |
| SSB | Synchronisation Signaling Block |
| | (also SS/PBCH block) |
| SVD | Singular-value decomposition |
| TDM | Time Division Multiplex |
| UCI | Uplink Control Information |
| UE | User Equipment |
| UL | Uplink |
| URLLC | Ultra Low Latency High Reliability Communication |
| USS | UE-specific Search Space |
| TX | Transmitter, transmitter-side |
| VL-M IMO | Very-large multiple-input-multiple-output |
| ZF | Zero Forcing |

Abbreviations may be considered to follow 3GPP usage if applicable.

1. A method of operating a network node in a radio access network, the method comprising:
configuring at least one user equipment, UE, with an uplink transmission configuration for transmission of uplink signaling based on a reception beam configuration of the network node.

2. A network node for a radio access network, the network node configured to:
configure at least one user equipment, UE, with an uplink transmission configuration for transmission of uplink signaling based on a reception beam configuration of the network node.

3. A method of operating a user equipment, UE, in a radio access network, the method comprising:
transmitting uplink signaling based on an uplink transmission configuration configured to the user equipment, the uplink transmission configuration being based on a beam reception beam configuration of a network node.

4. A user equipment, UE, for a radio access network, the user equipment configured to:
transmit uplink signaling based on an uplink transmission configuration configured to the user equipment, the uplink transmission configuration being based on a beam reception beam configuration of a network node.

5. The method according to claim 1, wherein the reception beam configuration represents one of analog and hybrid reception beamforming.

6. The method according to claim 1, wherein the reception beam configuration represents at least one of beam sweeping and beam switching.

7. The method according to claim 1, wherein the uplink transmission configuration represents an opportunity for transmission of a scheduling request on a physical uplink control channel, wherein the scheduling request represents one of 1 bit and more than 1 bits.

8. The method according to claim 1, wherein the uplink transmission configuration represents an opportunity for transmission of a scheduling request on a physical uplink control channel, wherein the scheduling request is represented by at least one of a long transmission, and repeated N times.

9. The method according to claim 1, wherein the uplink transmission configuration represents an opportunity for transmission on a physical uplink shared channel, wherein the uplink transmission configuration is configured at least one of preempting, and in lieu of a scheduling request.

10. The method according to claim 1, wherein the uplink transmission configuration is scheduled at least one of dynamically and with physical layer signaling.

11. The method according to claim 1, wherein the uplink transmission configuration is configured at least one of semi-statically and with higher layer signaling.

12. The method according to claim 1, wherein the uplink transmission configuration represents an opportunity of transmission of multiple feedback-independent scheduling requests.

13. The method according to claim 1, wherein the uplink transmission configuration represents an opportunity of transmission of a scheduling request in a format covering a plurality of M symbol time intervals.

14. A computer storage medium storing a computer program comprising instructions that when executed cause processing circuitry to at least one of control and perform a method comprising:
configuring at least one user equipment, UE, with an uplink transmission configuration for transmission of uplink signaling based on a reception beam configuration of the network node.

15. (canceled)

16. The method according to claim 3, wherein the reception beam configuration represents at least one of beam sweeping and beam switching.

17. The method according to claim 3, wherein the uplink transmission configuration represents an opportunity for transmission of a scheduling request on a physical uplink control channel, wherein the scheduling request represents one of 1 bit and more than 1 bits.

18. The method according to claim 3, wherein the uplink transmission configuration represents an opportunity for transmission of a scheduling request on a physical uplink control channel, wherein the scheduling request is represented by at least one of a long transmission and repeated N times.

19. The method according to claim 3, wherein the uplink transmission configuration represents an opportunity for transmission on a physical uplink shared channel, wherein the uplink transmission configuration is configured at least one of preempting and in lieu of a scheduling request.

20. The method according to claim 10, wherein the physical layer signaling is downlink control information signaling.

21. The method according to claim 11, wherein the higher layer signaling is radio resource control, RRC, signaling.
